(19) United States
(12) Patent Application Publication
(10) Pub. No.: US 2006/0109409 A1
(43) Pub. Date: May 25, 2006

(54) LCD panel with provision for data line repair

(75) Inventor: Chien-Ting Lai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/285,128

(22) Filed: Nov. 21, 2005

(30) Foreign Application Priority Data
Nov. 19, 2004 (TW) 93135567

(51) Int. Cl. G02F 1/1343

(52) U.S. Cl. 349/139

(57) ABSTRACT

A liquid crystal display panel includes two substrates and a liquid crystal layer interposed therebetween. One substrate (101) has a plurality of interlaced gate lines (110) and data lines (120), thereby defining a plurality of display pixels (100). The display pixels are covered by a passivation layer (103). A plurality of pixel electrodes (140) is formed on the passivation layer within the display pixels respectively. The data line and the pixel electrode in each display pixel overlap and/or underlie each other at at least two separate locations (121, 122).

### BACKGROUND OF THE INVENTION

1. Field of the Invention

The present invention relates to liquid crystal display panels, and in particular to a liquid crystal display panel with a line defect repairing structure.

2. General Background

Liquid crystal displays (LCD) are one of the most popular flat displays. The panel of a conventional LCD basically has interlaced gate lines and data lines, which define a plurality of display pixels. Each display pixel has a pixel electrode and a thin film transistor (TFT). The TFT is controlled by control signals provided through the gate line, and thereby enables the pixel electrode. The orientation of liquid crystal molecules is controlled by the pixel electrode according to a driving voltage provided through the data line, such that the polarization of light passing through the liquid crystal molecules can be modulated to display images.

Conventionally, driving signals for different display pixels in a same column of pixels are transferred through a same data line. When a data line is open or damaged, driving signals cannot reach the following display pixels, thus causing a dark line defect.

FIG. 4 is a schematic top view of a display pixel of a conventional LCD panel as disclosed in U.S. Publication No. 2002050967 published on May 2, 2002. The LCD panel has display pixels 10 defined by interlaced gate lines 1 and data lines 2. Each display pixel 10 has a pixel electrode 4, and a TFT 3 connected to the corresponding gate line 1. Driving signals can be provided to the pixel electrode 4 when the TFT 3 is enabled. A capacitor 5 is cooperatively formed by the pixel electrode 4 and another gate line 1 of the same display pixel 10, to keep the driving voltage from the data line 2 when the TFT 3 is turned off.

The display pixel 10 further has two repairing conductive layers 6 between the two gate lines 1. The repairing conductive layers 6 are located under two corresponding data lines 2 respectively, with an insulation layer being disposed between each repairing conductive layer 6 and the respective data line 2. When a break or defect exists or occurs on a data line 2, such as the left-hand data line 2 shown in FIG. 4, the data line 2 can be reconnected by laser melting the insulation layer between the data line 2 and repairing conductive layer 6 at two positions A. Thus, defects on data lines 2 can be rapidly repaired, and driving signals can reach the pixel electrodes 4 through the data lines 2.

As seen in FIG. 4, the length of each repairing conductive layer 6 is substantially equal to the length of each data line 2 in the display pixel 10. However, only a short portion of the repairing conductive layer 6 is used for each defect repair, and the other portions are wasted. Hence, there is a need for a more efficient repairing structure for an LCD panel.

### SUMMARY

Embodiments of the invention provide a liquid crystal display panel with an improved repairable layout to reduce panel reworking costs.

Embodiments of the invention provide a liquid crystal display panel including a first substrate, a second substrate, and a liquid crystal layer interposed between two substrates. The second substrate has a plurality of interlaced gate lines and data lines, thereby defining a plurality of display pixels. The display pixels are covered by a passivation layer. A plurality of pixel electrodes is formed on the passivation layer, within the display pixels respectively. The data line and pixel electrode in each display pixel overlap and/or underlie each other at at least two separate locations. In exemplary embodiments of the present invention, the data line in each display pixel has at least two protruding end portions underlying the pixel electrode, or the pixel electrode in each display pixel has at least two protruding end portions overlapping the data line.

Each display pixel of the second substrate further comprises a thin film transistor with a gate terminal connecting with a corresponding one of the gate lines, a source terminal connecting with the data line, and a drain terminal connecting with the pixel electrode. The passivation layer is made of one or more insulative materials, which may include for example silicon dioxide and/or silicon nitride.

Embodiments of the invention can be more fully understood by reading the below detailed description and examples with references made to the accompanying drawings, wherein:

### BRIEF DESCRIPTION OF THE DRAWINGS

FIG. 1 is a schematic top view of a display pixel of an LCD panel of a first exemplary embodiment of the present invention;

FIG. 2 is a cross-sectional view taken along line “II-II” of FIG. 1;

FIG. 3 is a schematic top view of a display pixel of an LCD panel of a second exemplary embodiment of the present invention; and

FIG. 4 is a schematic top view of a display pixel of a conventional LCD panel.

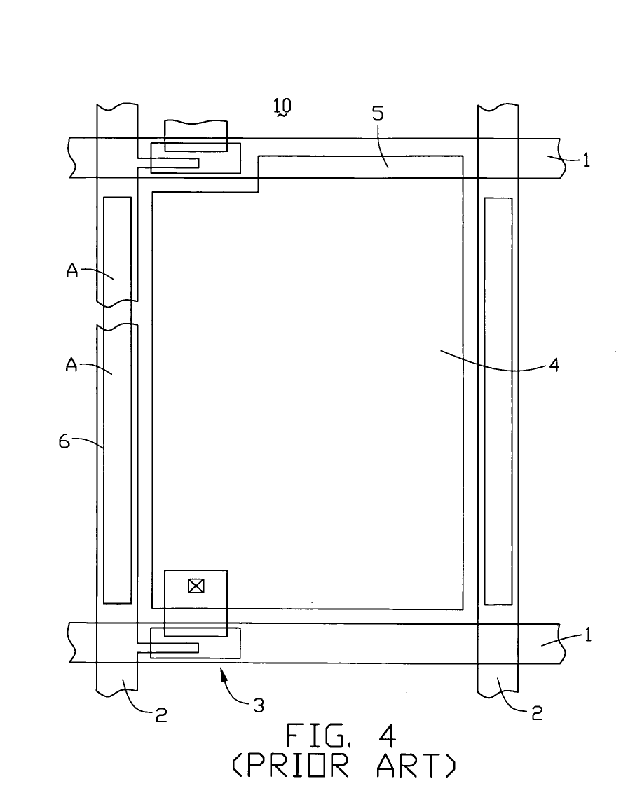

### DETAILED DESCRIPTION OF PREFERRED EMBODIMENTS

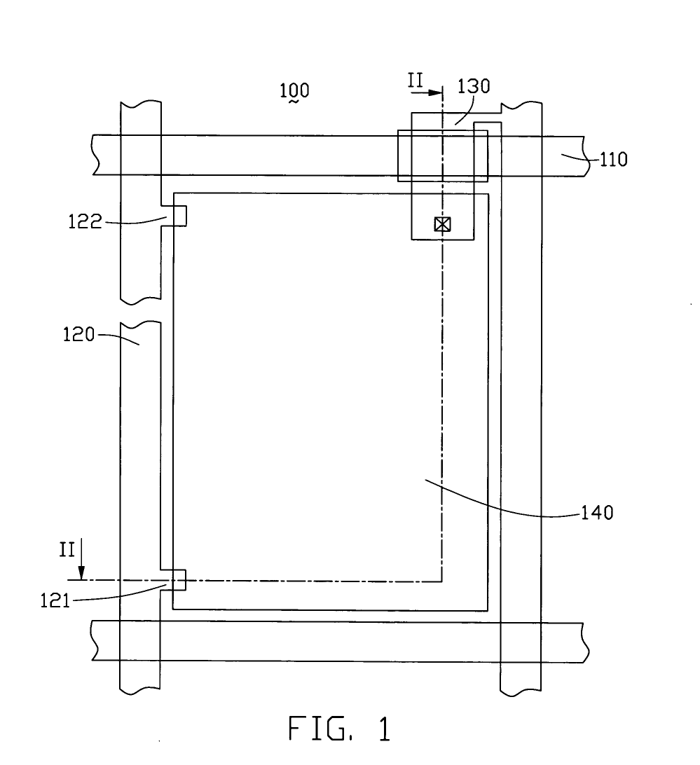

FIG. 1 shows a display pixel 100 of a liquid crystal display (LCD) panel of a first exemplary embodiment of the present invention. The LCD panel includes two substrates, and a liquid crystal layer interposed between the substrates. One substrate has a plurality of interlaced gate lines 110 and data lines 120, thereby defining a rectangular array of display pixels 100. Each display pixel 100 has a pixel electrode 140 and a thin film transistor (TFT) 130. The gate terminal of the TFT 130 is connected to the corresponding gate line 110, the source terminal of the TFT 130 is connected to the corresponding data line 120, and the drain terminal of the TFT 130 is connected to the pixel electrode 140. The TFT 130 is controlled by control signals provided through the gate line 110. A driving voltage for the pixel electrode 140 in the display pixel 100 is provided when the TFT 130 is enabled. Thus the orientation of liquid crystal molecules in the liquid crystal layer can be controlled by the pixel electrode 140 according to the driving voltage provided through the data line 120, and the polarization of light passing through the liquid crystal layer can be modulated to display images.

The data line 120 of the first exemplary embodiment further has two protruding end portions 121, 122 respectively at two opposite portions thereof that are near the gate lines 110 of the display pixel 100. The protruding end portions 121, 122 of the data line 120 underlie the pixel electrode 140, and can act as two joint points for repairing of defects in the data line 120. In alternative embodiments, there may be three or more of the protruding end portions 121, 122.

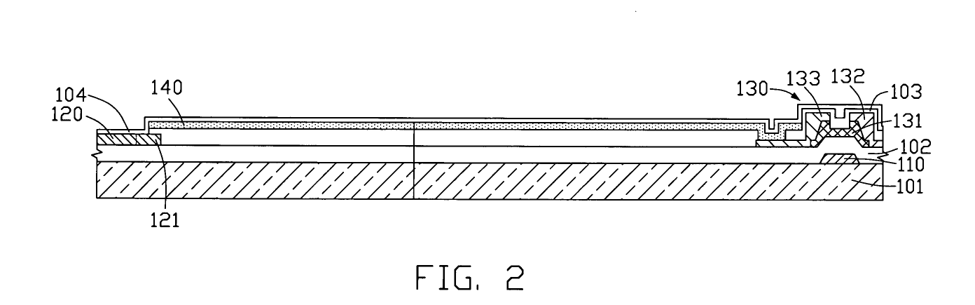

FIG. 2 is a cross-sectional view taken along line “II-II” of FIG. 1. Referring to FIGS. 1 and 2, the gate lines 110 of each display pixel 100 are patterned from a metal layer deposited on the substrate 101, and are covered by an insulation layer 102. An amorphous silicon layer is then deposited on the insulation layer 102 above each gate line 110. The amorphous silicon layer is then patterned, thereby forming a plurality of semi-conductive channels 131 for the TFTs 130. Next, a conductive layer is deposited and patterned, thereby forming the data line 120, the source terminal 132 and the drain terminal 133 of each TFT 130. Then a passivation layer 103 is covered on the TFTs 130 and the data lines 120. Next, a plurality of pixel electrodes 140 is formed on most parts of the passivation layer 103. Finally, an alignment layer 104 is formed to cover all of a top surface of the substrate 101 having the above-described components.

The passivation layer 103 is made of one or more insulative materials which may for example include silicon dioxide (SiO₂) and/or silicon nitride (SiNx). The passivation layer 103 separates each data line 120 from the corresponding pixel electrode 140. As seen in FIG. 2, each data line 120 of the first exemplary embodiment has a pair of protruding end portions 121, 122. The end portions 121, 122 extend to positions beneath the pixel electrode 140, thereby providing overlapped portions for repairing of a break or defect in the data line 120. As shown in FIG. 2, when a break or defect exists or occurs on the data line 120, the data line 120 can be reconnected by laser melting of the passivation layer 103 that is located between the protruding end portions 121, 122 and the pixel electrode 140. Thus, defects on data lines 120 can be rapidly repaired, and driving signals can reach following display pixels 100 in a same column of the array.

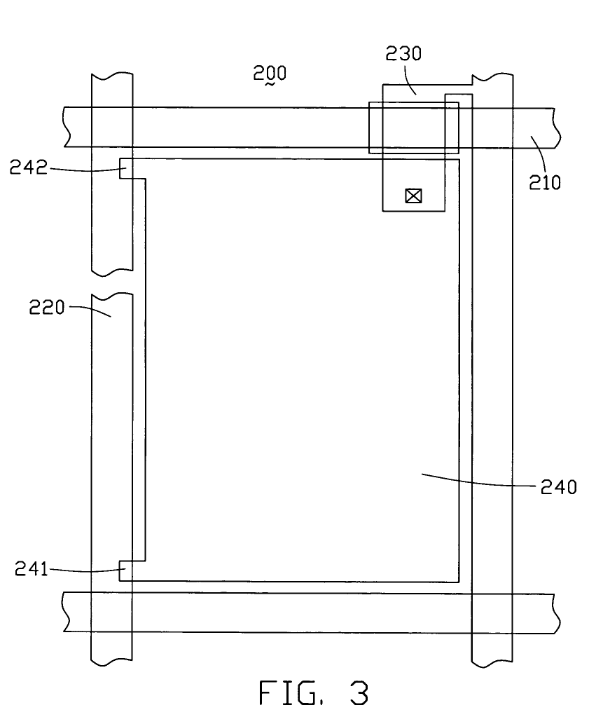

FIG. 3 shows a display pixel 200 of an LCD panel of a second exemplary embodiment of the present invention. The LCD panel has two substrates, and a liquid crystal layer interposed between the substrates. One substrate has a plurality of interlaced gate lines 210 and data lines 220, thereby defining a regular array of display pixels 200. Each display pixel 200 has a pixel electrode 240 and a TFT 230. The gate terminal of the TFT 230 is connected to the corresponding gate line 210, the source terminal of the TFT 230 is connected to the corresponding data line 220, and the drain terminal of the TFT 230 is connected to the pixel electrode 240.

The pixel electrode 240 of the second exemplary embodiment further has two protruding end portions 241, 242 respectively at two opposite ends thereof that are near the gate lines 210 of the display pixel 200. The protruding end portions 241, 242 of the pixel electrode 240 overlap the data line 220, and can act as two joint points for repairing of a break or defect in the data line 220. When a break or defect exists or occurs on the data line 220, the data line 220 can be reconnected by laser melting of a passivation layer (not shown) that is located between the protruding end portions 241, 242 and the data line 220. Thus, defects on data lines 220 can be rapidly repaired, and driving signals can reach following display pixels 200 in a same column of the array. In alternative embodiments, there may be three or more of the protruding end portions 241, 242.

In the above-described embodiments, the process of repairing defective structures is simpler than that of prior art. Furthermore, the protruding end portions are relatively short. This can save much material, and also reduces the possibility of defects occurring at the overlapping areas.

It is to be further understood that even though numerous characteristics and advantages of the embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display panel, comprising:
a first substrate;
a second substrate disposed on the first substrate and comprising:
a plurality of interlaced gate lines and data lines defining a plurality of display pixels, which are covered by a passivation layer,
a plurality of pixel electrodes disposed on the passivation layer within the display pixels respectively, wherein the data line and the pixel electrode in each display pixel overlap and/or underlie each other at at least two separate locations; and
a liquid crystal layer interposed between the first substrate and the second substrate.

2. The liquid crystal display panel as claimed in claim 1, wherein the data line in each display pixel comprises at least two protruding end portions underlying the pixel electrode.

3. The liquid crystal display panel as claimed in claim 2, wherein each display pixel of the second substrate further comprises a thin film transistor, which comprises a gate terminal connecting with a corresponding one of the gate lines, a source terminal connecting with the data line, and a drain terminal connecting with the pixel electrode.

4. The liquid crystal display panel as claimed in claim 3, wherein the passivation layer is made of one or more insulative materials.

5. The liquid crystal display panel as claimed in claim 4, wherein the passivation layer is made of silicon dioxide.

6. The liquid crystal display panel as claimed in claim 4, wherein the passivation layer is made of silicon nitride.

7. The liquid crystal display panel as claimed in claim 1, wherein the pixel electrode in each display pixel comprises at least two protruding end portions overlapping the data line.

8. The liquid crystal display panel as claimed in claim 7, wherein each display pixel of the second substrate further comprises a thin film transistor, which comprises a gate terminal connecting with a corresponding one of the gate lines, a source terminal connecting with the data line, and a drain terminal connecting with the pixel electrode.

9. The liquid crystal display panel as claimed in claim 8, wherein the passivation layer is made of one or more insulative materials.

10. The liquid crystal display panel as claimed in claim 9, wherein the passivation layer is made of silicon dioxide.

11. The liquid crystal display panel as claimed in claim 9, wherein the passivation layer is made of silicon nitride.

12. A liquid crystal display panel, comprising:
a first substrate;
a second substrate disposed on the first substrate and comprising:
a plurality of interlaced gate lines and data lines defining a plurality of display pixels, which are covered by a passivation layer,
a plurality of pixel electrodes disposed on the passivation layer within the display pixels respectively, wherein at least one of the data line and the pixel electrode in each display pixel defines a protrusion overlap and/or underlie with the other; and
a liquid crystal layer interposed between the first substrate and the second substrate.
